(19) United States
(12) Patent Application Publication
(10) Pub. No.: US 2020/0026294 A1
(43) Pub. Date: Jan. 23, 2020

(54) METHOD FOR CONTROLLING VEHICLE IN AUTONOMOUS DRIVING SYSTEM AND APPARATUS THEREOF

(71) Applicant: LG ELECTRONICS INC., Seoul (KR)

(72) Inventor: Soryoung KIM, Seoul (KR)

(21) Appl. No.: 16/586,215

(22) Filed: Sep. 27, 2019

(30) Foreign Application Priority Data
Aug. 29, 2019 (KR) 10-2019-0106519

(51) Int. Cl. G05D 1/02; G05D 1/00; G06K 9/00; H04W 4/40; H04W 72/14

(52) U.S. Cl. CPC G05D 1/028; G05D 1/0088; G05D 1/0246; G05D 2201/0213; H04W 4/40; H04W 72/14; G06K 9/00805

(57) ABSTRACT

Disclosed is a method and apparatus for controlling a vehicle in an autonomous driving system. According to an embodiment of the present disclosure, a method for controlling a vehicle in an autonomous driving system sets a driving route of the vehicle based on an object recognition status of the vehicle and updates the object recognition status of the vehicle, thereby securing the quality of object recognition and object recognition-based autonomous driving services. According to the present disclosure, one or more of the autonomous vehicle, user terminal, and server may be related to artificial intelligence (AI) modules, unmanned aerial vehicles (UAVs), robots, augmented reality (AR) devices, virtual reality (VR) devices, and 5G service-related devices.

### CROSS-REFERENCE TO RELATED APPLICATION(S)

This application is based on and claims priority under 35 U.S.C. 119 to Korean Patent Application No. 10-2019-0106519, filed on Aug. 29, 2019, in the Korean Intellectual Property Office, the disclosure of which is herein incorporated by reference in its entirety.

### TECHNICAL FIELD

The present disclosure relates to a method and apparatus for controlling a vehicle in an autonomous driving system and, more specifically, to a method and apparatus for controlling a vehicle to more precisely recognize an object in an autonomous driving system.

### DESCRIPTION OF RELATED ART

Vehicles may be classified into internal combustion engine vehicles, external combustion engine vehicles, gas turbine vehicles, and electric vehicles depending on how they are powered.

Autonomous vehicle refers to a self-driving or driverless car, and autonomous driving system denotes a system that monitors and controls autonomous vehicles to drive on their own.

In an autonomous driving system, vehicles conduct learning to gain more accurate object recognition in various environments. A vehicle learning process requires precise recognition of objects, such as pedestrians or obstacles.

When the autonomous vehicle recognizes objects, the object recognition model needs to be updated with object information detected from the road where the vehicle drives.

For more accurate object recognition, the system is required to reboot with a new algorithm. During the rebooting process, however, the object recognition functionality may not be used and passengers' driving safety may thus be threatened. After updated, the object recognition model may not run normally and, while driving, certain functions may stop working.

### SUMMARY

The present disclosure aims to address the foregoing issues and/or needs.

The present disclosure also aims to implement a vehicle control method and apparatus for safely updating the object recognition model of an autonomous vehicle in an autonomous driving system.

According to an embodiment of the present disclosure, a method for controlling a vehicle in an autonomous driving system comprises identifying an object recognition status of the vehicle, setting a driving route of the vehicle based on the object recognition status, and updating the object recognition status of the vehicle based on the driving route.

The method may further comprise receiving verification data related to a particular object in a section where the vehicle drives from a server of the autonomous driving system, wherein identifying the object recognition status may include determining a recognition status for the particular object based on the verification data.

Determining the recognition status for the particular object may include determining whether a recognition rate, for the particular object, of an object recognition model included in the vehicle is a reference value or more.

Setting the driving route of the vehicle may include transmitting a result of the determination of the recognition status for the particular object to the server, obtaining a driving route set based on the result of the determination of the recognition status from the server, and changing the driving route of the vehicle to the driving route obtained from the server.

Changing the driving route of the vehicle may include changing a driving area of the vehicle to a driving area meeting a condition determined by the server based on the result of the determination of the recognition status.

The driving area meeting the condition determined by the server may include an area in which a probability of presence of the particular object is a preset value or less.

The driving area meeting the condition determined by the server may include an area with a section, in which the probability of presence of the particular object is the preset value or less, has a particular length or longer.

The method may further comprise receiving, from a network, downlink control information (DCI) used for scheduling transmission of the object recognition status and transmitting the object recognition status to the network based on the DCI.

The driving area meeting the condition determined by the server may include an area behind another vehicle, which is set based on the result of the determination of the recognition status from the server.

Updating the object recognition status of the vehicle may include receiving an allocation of a physical sidelink shared channel (PSSCH) for receiving information related to updating the object recognition status from the other vehicle via a preset physical sidelink control channel (PSCCH) and receiving the update-related information from the other vehicle via the PSSCH.

According to an embodiment of the present disclosure, an apparatus for controlling a vehicle in an autonomous driving system comprises a processor controlling a function of the vehicle, a camera coupled with the processor and capturing an ambient image of the vehicle, a memory coupled with the processor and storing data for controlling the vehicle, and a communication unit coupled with the processor and transmitting or receiving the data for controlling the vehicle, wherein the processor identifies an object recognition status of the vehicle based on the ambient image captured by the camera, sets a driving route of the vehicle based on the object recognition status, and updates the object recognition status of the vehicle based on the driving route.

The processor may control the communication unit to receive verification data related to a particular object in a section where the vehicle drives from a server of the autonomous driving system and determines a recognition status for the particular object based on the verification data.

The processor may determine whether a recognition rate, for the particular object, of an object recognition model included in the vehicle is a reference value or more.

The processor may control the communication unit to transmit a result of the determination of the recognition status for the particular object to the server, control the communication unit to obtain a driving route set based on the result of the determination of the recognition status from the server, and change the driving route of the vehicle to the driving route obtained from the server.

The processor may control the communication unit to change a driving area of the vehicle to a driving area meeting a condition determined by the server based on the result of the determination of the recognition status.

The driving area meeting the condition determined by the server may include an area in which a probability of presence of the particular object is a preset value or less.

The driving area meeting the condition determined by the server may include an area with a section, in which the probability of presence of the particular object is the preset value or less, has a particular length or longer.

The processor may control the communication unit to receive, from a network, downlink control information (DCI) used for scheduling transmission of the object recognition status and transmit the object recognition status to the network based on the DCI.

The driving area meeting the condition determined by the server may include an area behind another vehicle, which is set based on the result of the determination of the recognition status from the server.

The processor may control the communication unit to receive an allocation of a physical sidelink shared channel (PSSCH) for receiving information related to updating the object recognition status from the other vehicle via a preset physical sidelink control channel (PSCCH) and receive the update-related information from the other vehicle via the PSSCH.

According to an embodiment of the present disclosure, a method and apparatus for controlling a vehicle in an autonomous driving system provide the following effects.

The present disclosure may quickly and safely learn objects which frequently appear according to the features of the area (e.g., road) where the autonomous vehicle drives, thereby securing the quality of object recognition and object recognition-based autonomous driving services.

The present disclosure may update the object recognition model with minimum learning data necessary for object recognition, thereby maximizing the use efficiency of vehicle resources necessary for the object recognition model.

The present disclosure may update the object recognition model without rebooting the autonomous driving function, thereby securing the continuity of autonomous driving-related services.

The present disclosure may stably provide autonomous driving-related services and ensure the safety of the passengers in the autonomous vehicle while driving.

The present disclosure may perform minimum updates necessary for updating the object recognition model, thereby minimizing the likelihood that an error occurs after update.

Effects of the present disclosure are not limited to the foregoing, and other unmentioned effects would be apparent to one of ordinary skill in the art from the following description.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an autonomous vehicle and a 5G network in a 5G communication system.

FIG. 4 shows an example of a basic operation between vehicles using 5G communication.

FIG. 5 illustrates a vehicle according to an embodiment of the present disclosure.

FIG. 6 is a control block diagram of the vehicle according to an embodiment of the present disclosure.

FIG. 7 is a control block diagram of an autonomous device according to an embodiment of the present disclosure.

FIG. 8 is a diagram showing a signal flow in an autonomous vehicle according to an embodiment of the present disclosure.

FIG. 9 is a diagram referred to describe a usage scenario of a user according to an embodiment of the present disclosure.

FIG. 10 is an example of V2X communication to which the present disclosure is applicable.

FIG. 11 shows a resource allocation method in a side-link where the V2X is used.

FIG. 12 is a block diagram illustrating an autonomous driving system according to an embodiment of the present disclosure;

FIG. 13 is a block diagram illustrating a vehicle controller for controlling an autonomous vehicle according to an embodiment of the present disclosure;

FIG. 14 is a block diagram illustrating a server according to an embodiment of the present disclosure;

FIG. 15 is a flowchart illustrating a method for controlling a vehicle according to an embodiment of the present disclosure;

FIG. 16 is a flowchart illustrating a method for identifying an object recognition status by a vehicle controller according to an embodiment of the present disclosure;

FIG. 17 is a flowchart illustrating the process of FIG. 16 as performed between a vehicle controller and a server;

FIG. 18 is a flowchart illustrating a method of setting a driving route by a vehicle controller according to an embodiment of the present disclosure; and

FIG. 19 is a flowchart illustrating a method of performing an update by a vehicle controller according to an embodiment of the present disclosure.

### DETAILED DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A. Example of Block Diagram of UE and 5G Network

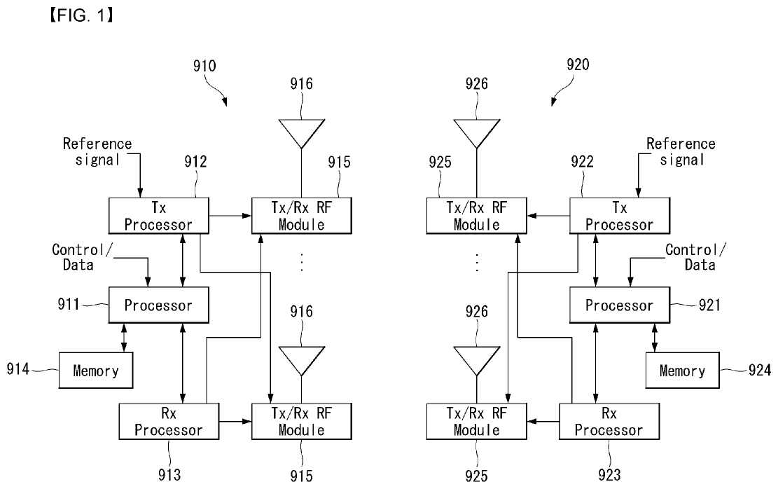

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

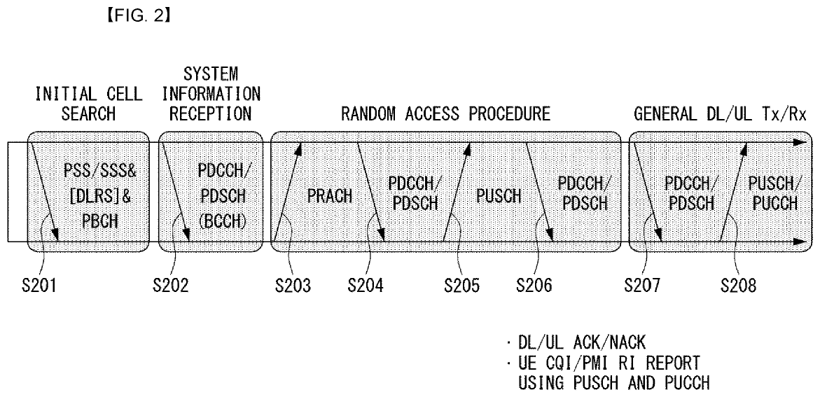

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling Here, the RRC parameter ‘repetition’ is set to ‘ON’.
   The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
   The UE determines an RX beam thereof.
   The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

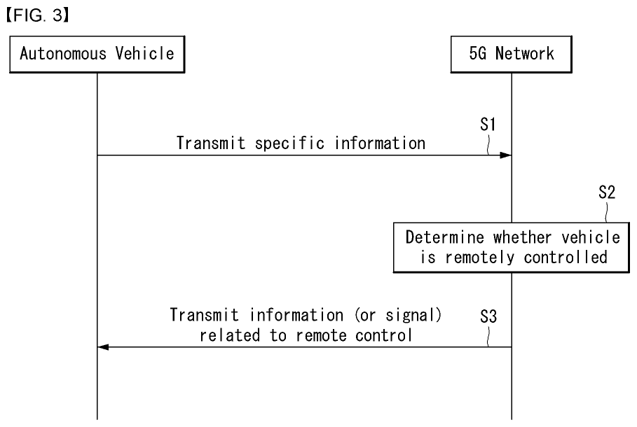

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present disclosure which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles Using 5G Communication

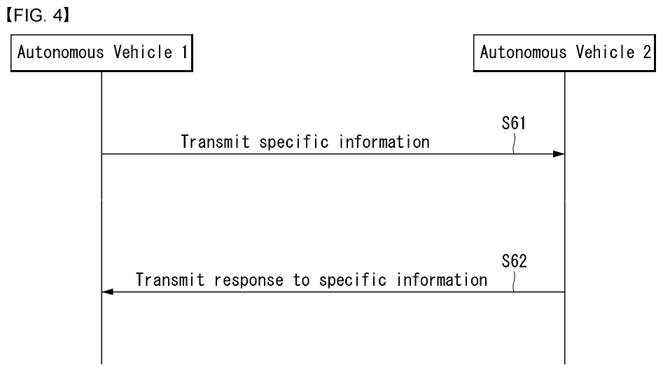

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present disclosure which will be described later and applied or can complement the methods proposed in the present disclosure to make technical features of the methods concrete and clear.

Driving

(1) Exterior of Vehicle

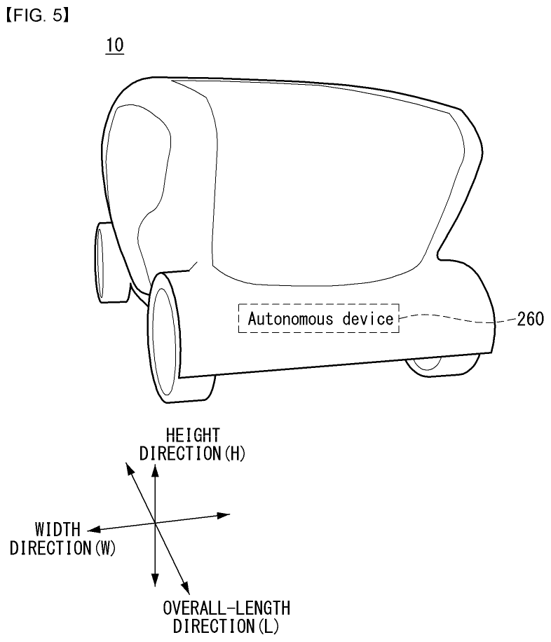

FIG. 5 is a diagram showing a vehicle according to an embodiment of the present disclosure.

Referring to FIG. 5, a vehicle 10 according to an embodiment of the present disclosure is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

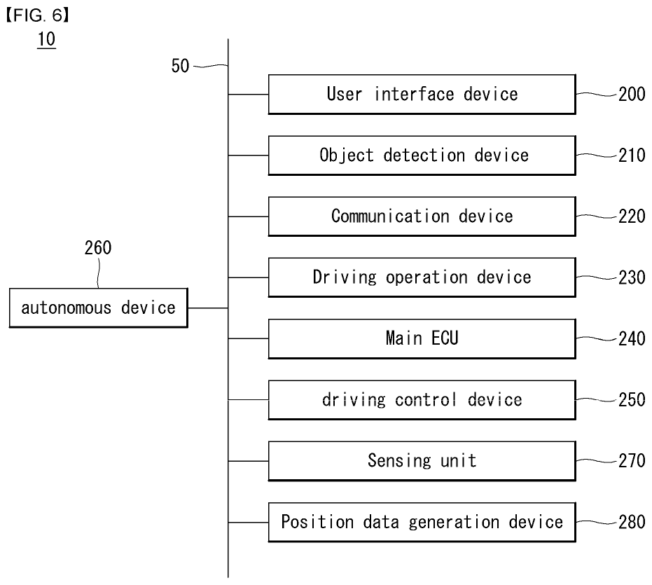

FIG. 6 is a control block diagram of the vehicle according to an embodiment of the present disclosure.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3) Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present disclosure can exchange signals with external devices using only one of C-V2X and DSRC. Alternatively, the communication device of the present disclosure can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

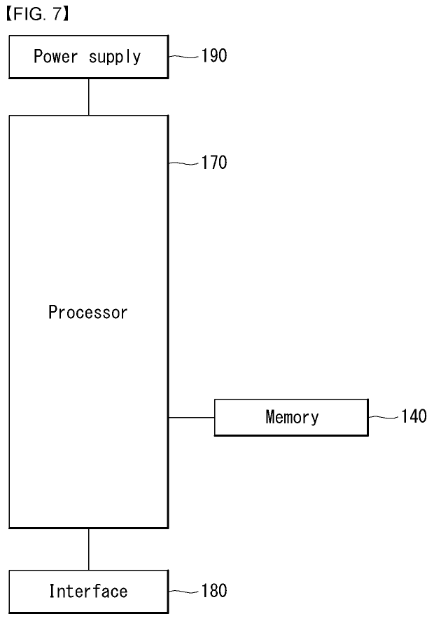

FIG. 7 is a control block diagram of the autonomous device according to an embodiment of the present disclosure.

Referring to FIG. 7, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

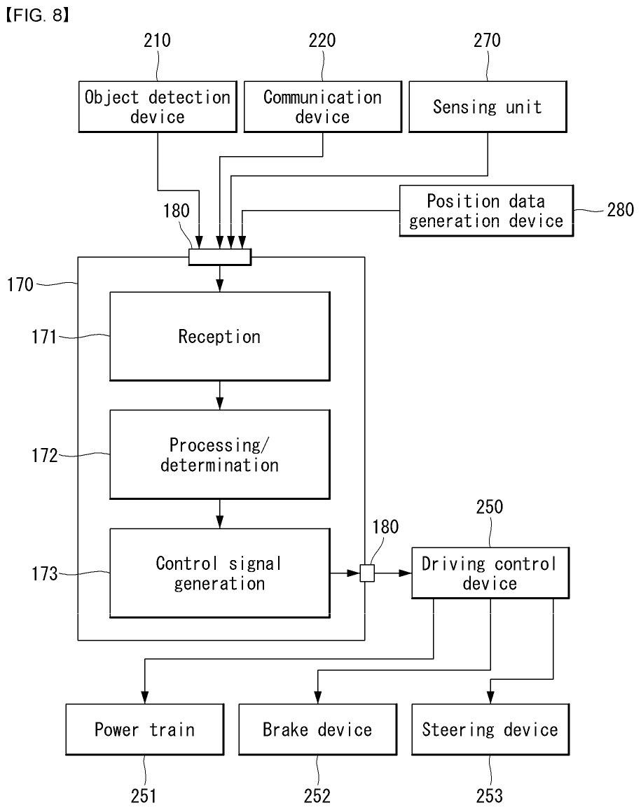

FIG. 8 is a diagram showing a signal flow in an autonomous vehicle according to an embodiment of the present disclosure.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

Autonomous Vehicle Usage Scenario

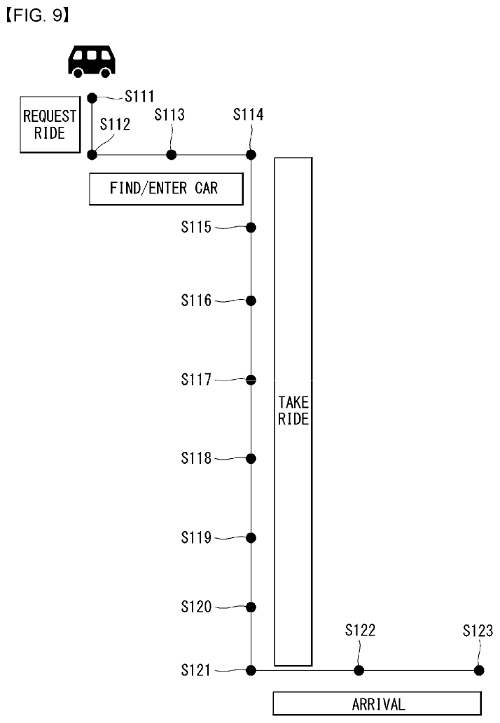

FIG. 9 is a diagram referred to describe a usage scenario of the user according to an embodiment of the present disclosure.

1) Destination Forecast Scenario

A first scenario S111 is a destination forecast scenario of the user. A user terminal may install an application that can be linked with a cabin system 300. The user terminal can forecast the destination of the user through the application based on user's contextual information. The user terminal may provide vacant seat information in a cabin through the application.

2) Cabin Interior Layout Countermeasure Scenario

A second scenario S112 is a cabin interior layout countermeasure scenario. The cabin system 300 may further include a scanning device for acquiring data on the user located outside a vehicle 300. The scanning device scans the user and can obtain physical data and baggage data of the user. The physical data and baggage data of the user can be used to set the layout. The physical data of the user can be used for user authentication. The scanning device can include at least one image sensor. The image sensor can use light in a visible light band or an infrared band to acquire an image of the user.

The seat system 360 can set the layout in the cabin based on at least one of the physical data and baggage data of the user. For example, the seat system 360 may provide a baggage loading space or a seat installation space.

3) User Welcome Scenario

A third scenario S113 is a user welcome scenario. The cabin system 300 may further include at least one guide light. The guide light may be disposed on a floor in the cabin. The cabin system 300 may output the guide light such that the user is seated on the seat, which is already set among the plurality of sheets when user's boarding is detected. For example, a main controller 370 may implement moving light through sequential lighting of a plurality of light sources according to the time from an open door to a predetermined user seat.

4) Seat Adjustment Service Scenario

A fourth scenario S114 is a seat adjustment service scenario. The seat system 360 may adjust at least one element of the seat that matches the user based on the acquired physical information.

5) Personal Content Provision Scenario

A fifth scenario S115 is a personal content provision scenario. A display system 350 can receive personal data of the user via an input device 310 or a communication device 330. The display system 350 can provide a content corresponding to the personal data of the user.

6) Product Provision Scenario

A sixth scenario S116 is a product provision scenario. A cargo system 355 can receive user data through the input device 310 or the communication device 330. The user data may include preference data of the user and destination data of the user. The cargo system 355 may provide a product based on the user data.

7) Payment Scenario

A seventh scenario S117 is a payment scenario. A payment system 365 can receive data for price calculation from at least one of the input device 310, the communication device 330 and the cargo system 355. The payment system 365 can calculate a vehicle usage price of the user based on the received data. The payment system 365 can require the user (that is, mobile terminal of user) to pay a fee at the calculated price.

8) User Display System Control Scenario

An eighth scenario S118 is a user display system control scenario. The input device 310 may receive a user input configured in at least one form and may convert the user input into an electrical signal. The display system 350 can control a content displayed based on the electrical signal.

9) AI Agent Scenario

A ninth scenario S119 is a multi-channel artificial intelligence (AI) agent scenario for multiple users. An AI agent 372 can distinguish the user input of each of multiple users. The AI agent 372 can control at least one of the display system 350, the cargo system 355, the seat system 360, and the payment system 365 based on the electric signal converted from the user input of each of the multiple users.

10) Multimedia Content Provision Scenario for Multiple Users

A tenth scenario S120 is a multimedia content provision scenario for multiple users. The display system 350 can provide a content that all users can view together. In this case, the display system 350 can individually provide the same sound to multiple users through a speaker provided in each sheet.

The display system 350 can provide a content that the multiple users individually can view. In this case, the display system 350 can provide an individual sound through the speaker provided in each sheet.

11) User Safety Securing Scenario

An eleventh scenario S121 is a user safety securing scenario. When vehicle peripheral object information that poses a threat to the user is acquired, the main controller 370 can control to output an alarm of the vehicle peripheral object via the display system 350.

12) Belongings Loss Prevention Scenario

A twelfth scenario S122 is a scenario for preventing loss of belongings of the user. The main controller 370 can obtain data on the belongings of the user via the input device 310. The main controller 370 can obtain user motion data through the input device 310. The main controller 370 can determine whether the user places the belongings and gets off based on the data of the belongings and the motion data. The main controller 370 can control to output an alarm of the belongings through the display system 350.

13) Get Off Report Scenario

A thirteenth scenario S123 is a get off report scenario. The main controller 370 can receive get off data of the user through the input device 310. After the user gets off, the main controller 370 can provide report data for the get off to the mobile terminal of the user through the communication device 330. The report data may include the entire usage fee data of the vehicle 10.

Vehicle-to-Everything (V2X)

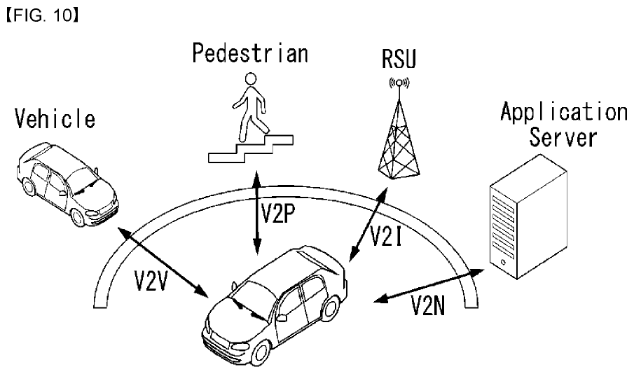

FIG. 10 is an example of V2X communication to which the present disclosure is applicable.

The V2X communication includes communication between a vehicle and all objects such as Vehicle-to-Vehicle (V2V) referring to communication between vehicles, Vehicle-to-Infrastructure (V2I) referring to communication between a vehicle and an eNB or a Road Side Unit (RSU), and Vehicle-to-Pedestrian (V2P) or a Vehicle-to-Network (V2N) referring to communication between a vehicle and a UE with an individual (pedestrian, bicycler, vehicle driver, or passenger).

The V2X communication may indicate the same meaning as V2X side-link or NR V2X, or may include a broader meaning including the V2X side-link or NR V2X.

For example, the V2X communication can be applied to various services such as forward collision warning, an automatic parking system, a cooperative adaptive cruise control (CACC), control loss warning, traffic matrix warning, traffic vulnerable safety warning, emergency vehicle warning, speed warning on a curved road, or a traffic flow control.

The V2X communication can be provided via a PC5 interface and/or a Uu interface. In this case, in a wireless communication system that supports the V2X communication, there may exist a specific network entity for supporting the communication between the vehicle and all the objects. For example, the network object may be a BS (eNB), the road side unit (RSU), a UE, an application server (for example, a traffic safety server), or the like.

In addition, the UE executing V2X communication includes not only a general handheld UE but also a vehicle UE (V-UE), a pedestrian UE, a BS type (eNB type) RSU, a UE type RSU, a robot having a communication module, or the like.

The V2X communication may be executed directly between UEs or may be executed through the network object(s). V2X operation modes can be divided according to a method of executing the V2X communication.

The V2X communication requires a support for UE pseudonymity and privacy when a V2X application is used so that an operator or a third party cannot track a UE identifier within a V2X support area.

Terms frequently used in the V2X communication are defined as follows.
Road Side Unit (RSU): The RSU is a V2X serviceable device that can perform transmission/reception with a moving vehicle using a V2I service. Furthermore, the RSU can exchange messages with other entities supporting the V2X application as a fixed infrastructure entity supporting the V2X application. The RSU is a term often used in the existing ITS specifications, and a reason for introducing this term in 3GPP specifications is to make it easy to read a document in an ITS industry. The RSU is a logical entity that combines a V2X application logic with functions of a BS (referred to as BS-type RSU) or a UE (referred to as UE-type RSU).
V2I service: A type of V2X service in which one is a vehicle and the other is an entity belongs to an infrastructure.
V2P service: A type of the V2X service in which one is a vehicle and the other is a device (for example, handheld UE carried by pedestrian, bicycler, driver, or passenger) carried by an individual.
V2X service: A 3GPP communication service type in which a transmitting or receiving device is related to a vehicle.
V2X enabled UE: A UE supporting the V2X service.
V2V service: A type of the V2X service in which both in the communication are vehicles.
V2V communication range: A range of direct communication between two vehicles participating in the V2V service.

As described above, the V2X application referred to as the V2X (Vehicle-to-Everything) includes four types such as (1) Vehicle-to-VEHICLE (V2V), (2) Vehicle-to-infrastructure (V2I), (3) Vehicle-to-Network (V2N), and (4) Vehicle-to-Pedestrian (V2P).

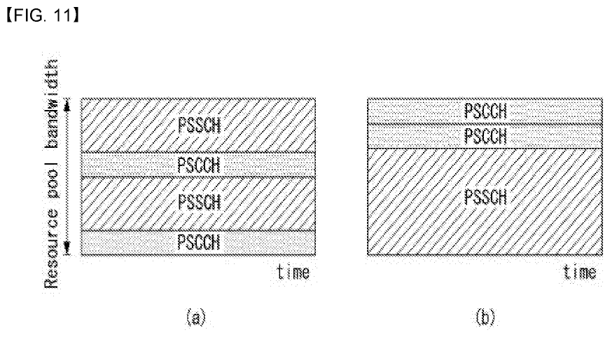

FIG. 11 shows a resource allocation method in a side-link where the V2X is used.

In the side-link, different physical side-link control channels (PSCCHs) may be separately allocated in a frequency domain, and different physical side-link shared channels (PSSCHs) may be separately allocated. Alternatively, different PSCCHs may be allocated consecutively in the frequency domain, and PSSCHs may also be allocated consecutively in the frequency domain.

NR V2X

In order to extend a 3GPP platform to a vehicle industry during 3GPP release 14 and 15, supports for the V2V and V2X services are introduced in LTE.

Requirement for supports with respect to an enhanced V2X use case are broadly divided into four use case groups.

(1) A Vehicle Platooning can dynamically form a platoon in which vehicles move together. All vehicles in the platoon get information from the top vehicle to manage this platoon. These pieces of information allow the vehicles to be operated in harmony in the normal direction and to travel together in the same direction.

(2) Extended sensors can exchange raw data or processed data collected by a local sensor or a live video image in a vehicle, a road site unit, a pedestrian device, and a V2X application server. In the vehicle, it is possible to raise environmental awareness beyond what a sensor in the vehicle can sense, and to ascertain broadly and collectively a local situation. A high data transmission rate is one of main features.

(3) Advanced driving allows semi-automatic or full-automatic driving. Each vehicle and/or the RSU shares own recognition data obtained from the local sensor with a proximity vehicle and allows the vehicle to synchronize and coordinate a trajectory or maneuver. Each vehicle shares a driving intention with the proximity vehicle.

(4) Remote driving allows a remote driver or the V2X application to drive the remote vehicle for a passenger who cannot drive the remote vehicle in his own or in a dangerous environment. If variability is restrictive and a path can be forecasted as public transportation, it is possible to use Cloud computing based driving. High reliability and a short waiting time are important requirements.

The above-describe 5G communication technology can be combined with methods proposed in the present disclosure which will be described later and applied or can complement the methods proposed in the present disclosure to make technical features of the present disclosure concrete and clear.

Hereinafter, various embodiments of the present disclosure will be described in detail with reference to the attached drawings.

The above-described present disclosure can be implemented with computer-readable code in a computer-readable medium in which program has been recorded. The computer-readable medium may include all kinds of recording devices capable of storing data readable by a computer system. Examples of the computer-readable medium may include a hard disk drive (HDD), a solid state disk (SSD), a silicon disk drive (SDD), a ROM, a RAM, a CD-ROM, magnetic tapes, floppy disks, optical data storage devices, and the like and also include such a carrier-wave type implementation (for example, transmission over the Internet). Therefore, the above embodiments are to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

Furthermore, although the disclosure has been described with reference to the exemplary embodiments, those skilled in the art will appreciate that various modifications and variations can be made in the present disclosure without departing from the spirit or scope of the disclosure described in the appended claims. For example, each component described in detail in embodiments can be modified. In addition, differences related to such modifications and applications should be interpreted as being included in the scope of the present disclosure defined by the appended claims.

Although description has been made focusing on examples in which the present disclosure is applied to automated vehicle & highway systems based on 5G (5 generation) system, the present disclosure is also applicable to various wireless communication systems and autonomous devices.

Hereinafter, various embodiments of the present disclosure will be described in detail with reference to the accompanying drawings.

M. Specific Operations of the Present Disclosure

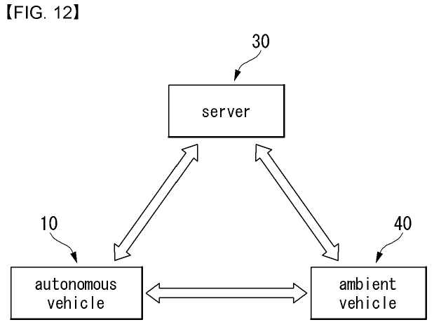

FIG. 12 is a block diagram illustrating an autonomous driving system according to an embodiment of the present disclosure.

Referring to FIG. 12, according to an embodiment of the present disclosure, an autonomous vehicle 10 in an autonomous driving system may perform wired/wireless communication with a server 30 and an ambient vehicle 40.

For example, the autonomous vehicle 10 may perform wireless communication with the server 30 via a 5G network as described above in connection with FIGS. 1 to 3.

The autonomous vehicle 10 may perform wireless communication with the ambient vehicle 40 via V2X communication as described above in connection with FIGS. 9 to 11.

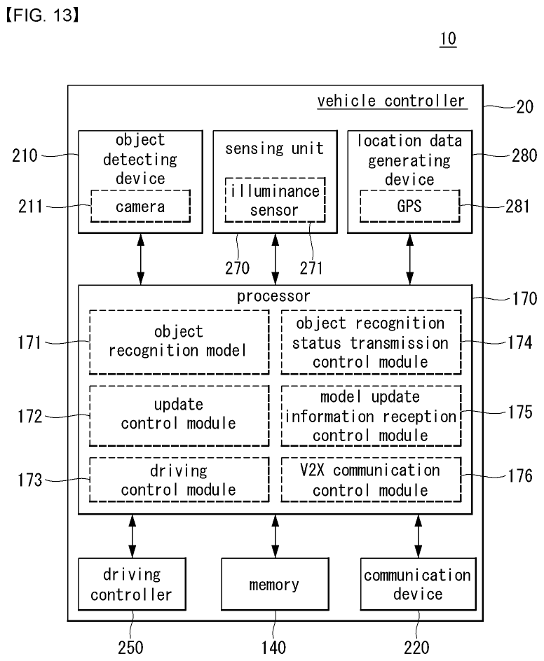

FIG. 13 is a block diagram illustrating a vehicle controller for controlling an autonomous vehicle according to an embodiment of the present disclosure.

Referring to FIG. 13, a vehicle controller 20 for controlling the autonomous vehicle 10 may include at least one of the components of the autonomous vehicle 10 as described above in connection with FIGS. 6 to 8 and is described below in greater detail.

Specifically, the vehicle controller 20 may include an object detecting device 210, an sensing unit 270, a location data generating device 280, a processor 170, a driving controller 250, a memory 140, and a communication device 220 of the autonomous vehicle 10, and the components may perform all of the functions of the components described above in connection with FIGS. 6 to 8.

The object detecting device 210 may include a camera 211 that captures the views in front of, behind, and to the sides of the autonomous vehicle 10 and transmits the captured images to the processor 170.

The sensing unit 270 may include an illuminance sensor 271 that senses the ambient illuminance of the autonomous vehicle 10 and obtains a sensing value for determining the current driving circumstance (e.g., weather) of the autonomous vehicle 10.

The location data generating device 280 may include a global positioning system (GPS) (or a GPS device) 281 for generating GPS data for the autonomous vehicle 10.

The processor 170 may include at least one of the processor 170 of the autonomous driving device 260 or the main ECU 240 of the autonomous vehicle 10 and may perform at least one of the functions of the processor 170 of the autonomous driving device 260 or the main ECU 240 of the autonomous vehicle 10 described above in connection with FIGS. 6 to 8.

Specifically, the processor 170 may control the functions of the components of the vehicle controller 20 of FIG. 13. For example, the processor 170 may control the camera 211 to capture an ambient image of the autonomous vehicle 10 and obtain the ambient image of the autonomous vehicle 10 from the camera 211. The processor 170 may control the illuminance sensor 271 to detect the ambient illuminance of the autonomous vehicle 10 and determine the driving circumstance (e.g., clear or cloudy weather) of the autonomous vehicle 10 based on the detected illuminance. The processor 170 may control the GPS 281 to obtain GPS data, generate location information about the autonomous vehicle 10 based on the GPS data, and control the driving status and driving area of the autonomous vehicle 10 based on the location information about the autonomous vehicle 10. The processor 170 may read driving setting data stored in the memory 140 and control the driving of the autonomous vehicle 10 based on the read driving setting data. The processor 170 may control the communication device 220 to transmit or receive data to/from the server 30 or the ambient vehicle 40. The processor 170 may control the driving controller 250 to control the autonomous vehicle 10 in the set driving area/driving status.

The processor 170 may include an object recognition model 171 for recognizing a particular object based on learning data received from the server 30 via the communication device 220 or the ambient images captured by the camera 211. The processor 170 may include an update control module 172 for performing/controlling an update on the object recognition model 171 based on the learning target object received from the server 30 via the communication device 220. The processor 170 may include a driving control module 173 for controlling the driving controller 250 based on the set driving area and driving status.

The processor 170 may include an object recognition status transmission control module 174 for transmitting an object recognition status for the particular object of the object recognition model 171 (e.g., a recognition rate for the particular object or whether it is required to learn the particular object determined based on the recognition rate for the particular object) to the server 30 or the ambient vehicle 40 via the communication device 220. The processor 170 may include a model update information reception control module 175 for receiving information for updating the object recognition model 171 capable of recognizing the object set as the learning target object by the server 30 from the server 30 via the communication device 220. The processor 170 may include a V2X communication control module 176 for sending a request for assisting in update to the ambient vehicle 40 and receiving information for updating the object recognition model from the ambient vehicle 40.

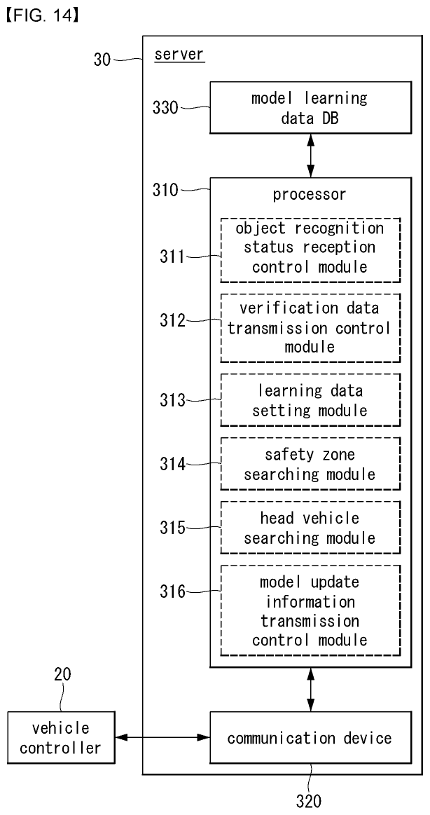

FIG. 14 is a block diagram illustrating a server according to an embodiment of the present disclosure.

Referring to FIG. 14, according to an embodiment of the present disclosure, the server 30 may include a processor 310, a communication device 320, and a model learning data database (DB) 330 which are described below in detail.

For example, the server 30 may include the communication device 320 for transmitting and receiving data to/from the vehicle controller 20.

The server 30 may include the model learning data DB 330 storing learning data for training the object recognition model of the vehicle controller 20.

The server 30 may include the processor 310 for reading data from the model learning data DB 330 and controlling the communication device 320 to transmit the set data to the vehicle controller 20.

Specifically, the processor 310 may include an object recognition status reception control module 311 for controlling the communication device 320 to receive the object recognition status from the vehicle controller 20. The processor 310 may include a verification data transmission control module 312 for transmitting verification data for verifying the object recognition model of the vehicle controller 20 to the vehicle controller 20 via the communication device 320 before receiving the object recognition status. The processor 310 may include a learning data setting module 313 for setting learning data based on the object recognition status. The processor 310 may include a safety zone searching module 314 for searching for a safety zone for the autonomous vehicle 10 to safely drive independently from updating the object recognition model. The processor 310 may include a head vehicle searching module 315 for searching for a head vehicle to allow the autonomous vehicle 10 to update the object recognition model based on V2X communication when the safety zone search fails. The processor 310 may include a model update information transmission control module 316 for transmitting model update information to the vehicle controller 20.

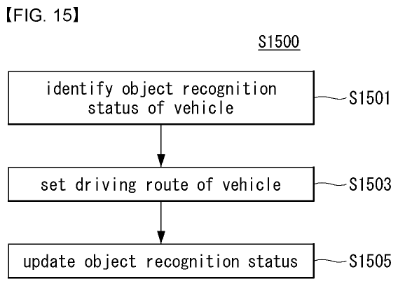

FIG. 15 is a flowchart illustrating a method for controlling a vehicle according to an embodiment of the present disclosure.

Referring to FIG. 15, according to an embodiment of the present disclosure, a method S1500 of controlling the autonomous vehicle 10 by the vehicle controller 20 may include steps S1501, S1503, and S1505 which are described below in detail.

For example, the vehicle controller 20 may enable the autonomous vehicle 10 to drive in a particular area while capturing the ambient image of the autonomous vehicle 10 by the camera 211, recognize an object included in the image, and transmit the results of object recognition to the server 30. The results of object recognition may include the name and location of the object, the accuracy (recognition rate) of the object recognition, the driving circumstance around the vehicle at the time of the object recognition (e.g., the weather determined based on the illuminance), and whether to update the object recognition model in the current driving area. The server 30 may divide the results of object recognition received from a plurality of vehicles based on the driving relevance with the area where each vehicle drives.

For example, in object recognition, the vehicle controller 20 may set only some among a plurality of sampled images obtained by sampling the ambient image based on the speed of the autonomous vehicle 10 and perform object recognition based on the set sampled images. This way may advantageously minimize the data computation loads on the vehicle controller 20 that recognizes objects since the same feature value for the particular object may be obtained in the plurality of sampled images as the speed of the autonomous vehicle 10 increases.

In addition to the sampled images for the ambient image obtained in real-time, the vehicle controller 20 may insert the learning data received in real-time from the server 30 to each sampled image and perform object recognition based on the sampled images and the learning data. In this case, the vehicle controller 20 may separately tag and store the obtained sampled images and the learning data in the memory.

Referring to FIG. 15, the processor 170 of the vehicle controller 20 may identify the object recognition status of the vehicle (S1501). The object recognition status of the vehicle may include recognition rate information about the particular object of the object recognition model or information about whether it is required to learn the particular object determined based on the recognition rate for the particular object.

Subsequently, the processor 170 may set a driving route of the vehicle based on the object recognition status of the vehicle (S1503). For example, the processor 170 may transmit the object recognition status of the vehicle to the server 30 and, if the server 30 sets a driving route (e.g., a driving area or a driving status) of the vehicle based on the object recognition status of the vehicle, the processor 170 may obtain the setting for the driving route of the vehicle from the server 30 via the communication device 220.

Then, the processor 170 may update the object recognition status (e.g., the object recognition model) based on the set driving route (S1505). For example, the processor 170 may receive learning data for learning the learning target object determined based on the object recognition status from the server 30 via the communication device 220 while driving the autonomous vehicle 10 along the set driving route and may update the object recognition model 171 for recognizing the learning target object based on the learning data.

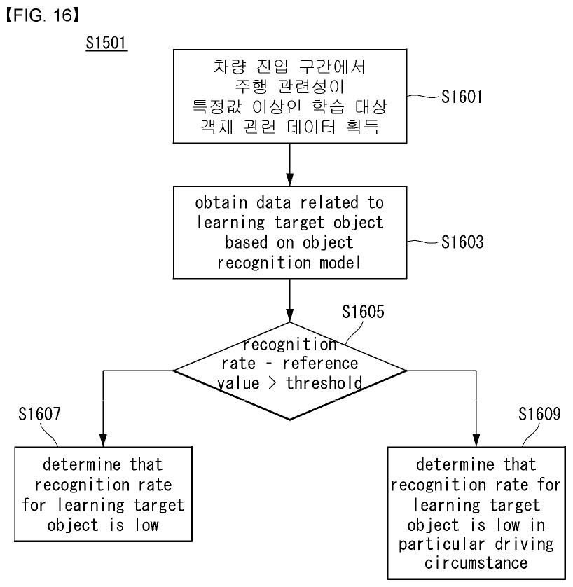

FIG. 16 is a flowchart illustrating a method for identifying an object recognition status by a vehicle controller according to an embodiment of the present disclosure.

Referring to FIG. 16, the processor 170 of the vehicle controller 20 may obtain data related to the learning target object whose driving relevance is a particular value or more in the section (area) which the vehicle has entered (S1601). The server 30 may obtain images captured in the section which a plurality of vehicles have entered and the results of recognition of objects in the images from the plurality of vehicles and determine the driving relevance of the plurality of objects in the section based on the images captured in the section and the results of recognition of the objects in the images obtained from the plurality of vehicles. For example, the processor 170 may control the communication device 220 to transmit the ambient image captured in the section which the vehicle is entering and/or the section (area) which the vehicle has entered to the server 30 and to obtain verification data related to the learning target object which is an object appearing a predetermined number of times or more in the section which the vehicle has entered (or a particular number of, or more, same learning target objects present in the section) from the server 30.

Subsequently, the processor 170 may determine the recognition rate for the learning target object based on the object recognition model (S1603). For example, the processor 170 may determine the recognition rate (e.g., accuracy) of the object recognition model 171 for the learning target object included in the verification data by applying the verification data related to the learning target object received from the server 30 to the object recognition model 171.

The processor 170 may determine whether the recognition rate minus a reference (e.g., an error between the recognition rate and the reference value) is larger than a preset threshold (S1605).

When the error is determined to be larger than the preset threshold, the processor 170 may determine that the recognition rate for the learning target object is low (S1607). For example, when the recognition rate for the learning target object of the object recognition model 171 is determined to be low, the processor 170 may receive high-accuracy learning data for the learning target object from the server 30.

When the error is determined to be the preset threshold or less, the processor 170 may determine that the recognition rate for the learning target object is low in a particular driving circumstance (S1609). For example, when the recognition rate for the learning target object of the object recognition model 171 in the particular driving circumstance is determined to be low, the processor 170 may receive high-accuracy learning data for the learning target object from the server 30 in the particular driving circumstance.

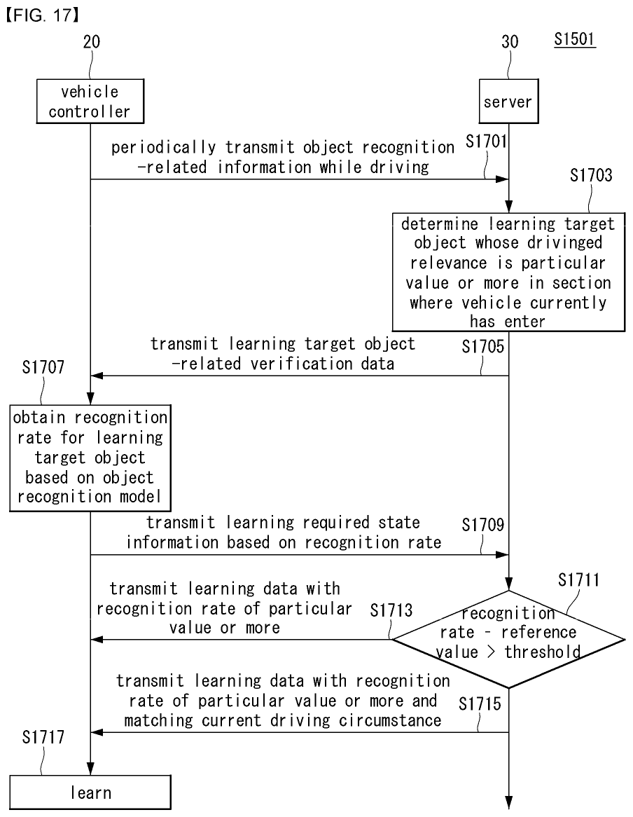

FIG. 17 is a flowchart illustrating the process of FIG. 16 as performed between a vehicle controller and a server.

Referring to FIG. 17, the vehicle controller 20 may periodically transmit object recognition-related information (results of object recognition) to the server 30 while driving (S1701).

Receiving the object recognition-related information from the vehicle controller 20, the server 30 may determine a learning target object with a driving relevance of a particular value or more in the current section which the vehicle has entered (S1703).

Then, the server 30 may transmit verification data related to the learning target object to the vehicle controller 20 (S1705). The verification data may include high-accuracy sample data of the image recognized by another vehicle for the learning target object and a reference accuracy for the object.

The vehicle controller 20 may obtain a recognition rate for the learning target object based on the object recognition model (S1707). For example, the vehicle controller 20 may perform object recognition on the learning target object included in the sample data for the learning target object included in the verification data based on the object recognition model 171 and obtain the results of object recognition (e.g., accuracy of recognition (or recognition rate) for the object) and information about whether the object needs to be learned (e.g., whether the recognition rate is a threshold or more).

Then, the vehicle controller 20 may transmit learning required state information including the obtained recognition rate and the information about whether learning is needed as determined based on the recognition rate to the server 30 (S1709).

The server 30 may analyze the recognition rate for the learning target object, which is included in the received learning required state information and determine whether the error between the recognition rate and the reference value is larger than a threshold (S1711).

When the error is determined to be larger than the threshold, the server 30 may transmit learning data whose recognition rate is a particular value or more to the vehicle controller 20 (S1713).

When the error is determined to be smaller than the threshold, the server 30 may transmit learning data, which has a recognition rate not less than the particular value and matches the current driving circumstance, to the vehicle controller 20 (S1715).

In other words, when the error is larger than the threshold, the server 30 may determine that the object recognition model 171 of the vehicle controller 20 has not been, or very little, trained with the object and, to perform learning on the object, transmit the learning data with a recognition rate of the particular value or more to the vehicle controller 20, thereby elevating the recognition rate, for the learning target object, of the object recognition model 171 of the vehicle controller 20. In contrast, if the error is smaller than the threshold, the server 30 may determine that the object recognition model 171 of the vehicle controller 20 has been trained with the object but the training is insufficient in the current driving circumstance (e.g., a cloudy weather) and, to perform learning on the object in the current driving circumstance, transmit the learning data with a recognition rate of the particular value or more in the current driving circumstance to the vehicle controller 20, thereby raising the recognition rate, for the learning target object, of the object recognition model 171 in the current driving circumstance.

The vehicle controller 20 may train the object recognition model 171 with the received learning data (S1717).

The training may be performed until the recognition rate, for the object, of the object recognition model 171 reaches the reference value, and the learning data may include a preset number of (e.g., 10) learning images.

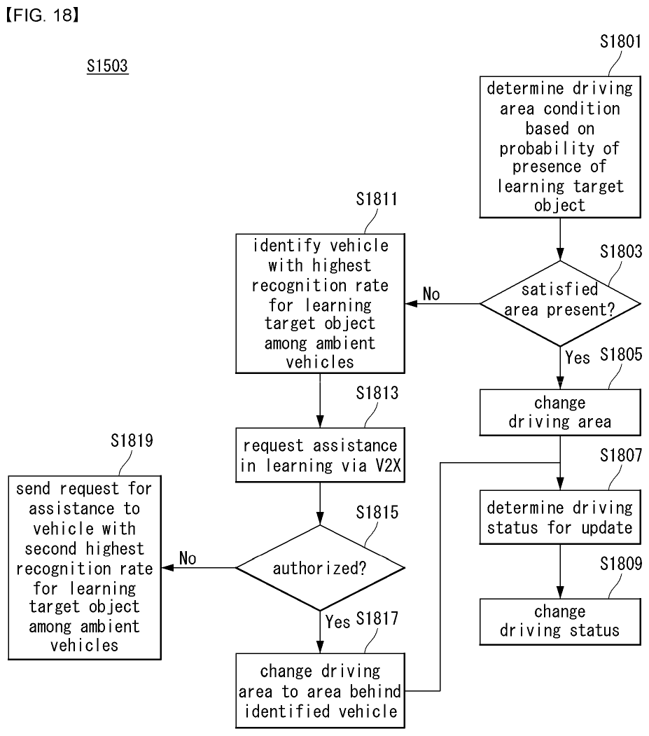

FIG. 18 is a flowchart illustrating a method of setting a driving route by a vehicle controller according to an embodiment of the present disclosure.

Referring to FIG. 18, the vehicle controller 20 may determine a condition regarding a driving area based on the probability of presence of a learning target object (S1801). For example, the processor 170 may determine, via the server 30, a driving area in which the probability of presence of a learning target object (or the probability of appearance of the learning target object) is a preset number or less and of which a section, in which the probability of presence in the learning target object is the present number, is a particular distance long or longer and the traffic volume is a particular value or less, among ambient driving areas (e.g., driving lanes). By driving on the driving area meeting the above conditions, the vehicle controller 20 may stably perform an update on the learning target object while driving on the driving area.

For example, an example of the driving area meeting the above conditions may be a lane furthest from the sidewalk, in which the traffic volume is not more than a particular value, and which has a section in which the probability of appearance of a pedestrian is 10% or less is 1 km long or longer.

Thereafter, the processor 170 may determine whether the ambient areas of the vehicle 10 include an area meeting the conditions determined in step S1801 (S1803).

When there is determined to be a driving area meeting the above conditions, the processor 170 may receive information for updating the object recognition model 171 including information regarding the driving area and the learning data for the learning target object from the server 30 and change the driving area of the autonomous vehicle 10 from the current driving area to the driving area meeting the conditions based on the update information (S1805). A specific example is described below.

As an example, for entering the lane furthest from the sidewalk among the driving areas, the processor 170 may identify the sidewalk area where the sidewalk is in from among the ambient areas of the vehicle 10. The processor 170 may obtain an ambient image, which is an image for the view in front of, behind, to the left side of, or preferably to the right side of the vehicle 10, from the camera of the vehicle 10. Then, the processor 170 may analyze the ambient image, thereby recognizing the area where people walk as a sidewalk area. If the sidewalk area is identified, the processor 170 may analyze the ambient image, identifying the passing lane furthest from the sidewalk area among at least one lane areas. If the passing lane is identified, the processor 170 may set a driving route for entering from the current lane area where the vehicle 10 is driving to the passing lane area. For example, the processor 170 may determine a shortest driving route set based on the distance between the current driving lane and the passing lane and relative speeds and positions to other vehicles driving around the vehicle 10.

As another example, for entering a well-flowing driving area in which the traffic volume is a particular value or less, the processor 170 may analyze the ambient image, determining the well-flowing driving area. The processor 170 may determine the well-flowing driving area based on relative distances between a plurality of ambient vehicles 40, distances between the vehicle 10 and the areas between the plurality of ambient vehicles 40, and an expected driving route of the vehicle 10 for entering the areas between the plurality of ambient vehicles 40.

If the sidewalk area and the well-flowing area are determined, the processor 170 may control the vehicle 10 to move to the sidewalk area/well-flowing area.

If no driving area meeting the conditions is determined to be among the ambient lanes, the processor 170 may identify the one with the highest recognition rate (e.g., accuracy) for the learning target object among at least one ambient vehicle 40 as a head vehicle (S1811). For example, the processor 170 may identify the head vehicle, which is the ambient vehicle with the highest recognition rate for the learning target object, via the server 30. The processor 170 may obtain, from the server 30, information related to the head vehicle identified to have the highest recognition rate for the learning target object and update information. The update information may include information about an object, learning data for the object, driving areas (safety zones) meeting conditions, verification data of the object recognition model 171 for the object, and reference accuracy for the object.

Then, the vehicle controller 20 may send a request for assisting in learning (or a request for assisting in update) to the head vehicle via V2X communication (S1813). For example, the learning assistance request may include information about the autonomous vehicle 10, the object requested for update, and information about the recognition rate, for the object, of the vehicle controller 20.

If the learning assistance request is authorized by the head vehicle, the vehicle controller 20 may change the driving area to the area behind the identified head vehicle (S1817).

For example, the vehicle controller 20 may change the driving area to the area behind the identified head vehicle based on the driving statuses of the ambient vehicles 40 present between the current location of the vehicle 10 and the area behind the identified head vehicle.

If the learning assistance request is declined by the head vehicle, the vehicle controller 20 may identify the vehicle with the second highest recognition rate for the learning target object among the at least one ambient vehicle 40 as a new head vehicle and transmit a learning assistance request to the new head vehicle (S1819).

For example, the vehicle controller 20 may change the driving area to the area behind the identified head vehicle based on the driving statuses of the ambient vehicles 40 present between the current location of the vehicle 10 and the area behind the identified new head vehicle.

After step S1817 or S1805, the vehicle controller 20 may determine a driving status for an update (S1807). For example, the vehicle controller 20 may determine a driving status including the location of the vehicle, inter-vehicle intervals, and the driving speed of the vehicle for safely performing an update. A specific example is described below.

As an example, to determine the location of the vehicle for safely performing an update, the vehicle controller 20 may determine the time necessary for updating and determine the optimal location of the vehicle 10 based on the time necessary for updating and relative positions to the ambient vehicles 40. For example, the optimal location may be an area meeting the driving area conditions determined in step S1801.

As another example, the vehicle controller 20 may determine information about the optimal interval between the vehicle 10 and the vehicle ahead among the ambient vehicles 40 based on the time necessary for updating. For example, the vehicle controller 20 may predict the acceleration of the vehicle ahead, predict the speed of the vehicle ahead during the time necessary for updating, predict the distance between the vehicle 10 and the vehicle ahead during the time necessary for updating based on the speed of the vehicle ahead, and determine the optimal interval information based on the predicted distance between the vehicle 10 and the vehicle ahead during the time necessary for updating.

As another example, the vehicle controller 20 may obtain the speed information of the vehicle ahead based on the time necessary for updating and determine the optimal speed of the vehicle 10 based on the speed information of the vehicle ahead. For example, the vehicle controller 20 may predict the acceleration of the vehicle ahead, predict the speed of the vehicle ahead during the time necessary for updating, and determine the optimal speed for maintaining a preset distance from the vehicle ahead during the time necessary for updating based on the predicted speed of the vehicle ahead during the time necessary for updating.

Subsequently, the vehicle controller 20 may change the driving status of the autonomous vehicle 10 to the determined driving status (S1809). A specific example is described below.

As an example, the vehicle controller 20 may determine the location of the vehicle for safe updating, determine a route to move to the determined location of the vehicle, and move to the location of the vehicle for safe updating based on the determined route.

As another example, the vehicle controller 20 may determine the optimal interval between the vehicle ahead and the vehicle 10 for safe updating, determine a driving route for maintaining the determined optimal interval between the vehicle 10 and the vehicle ahead, and control the vehicle 10 to maintain the interval between the vehicle 10 and the vehicle ahead for safe updating based on the determined route.

As another example, the vehicle controller 20 may determine a vehicle speed for safe updating and control the vehicle 10 at the determined vehicle speed.

The vehicle controller 20 may use the ambient image obtained by the head vehicle as learning data for the learning target object.

If the driving route of the head vehicle changes, the vehicle controller 20 may search for a new, different head vehicle via the server 30 or search for a nearby parking area and move the autonomous vehicle 10 to the parking area and continue the update.

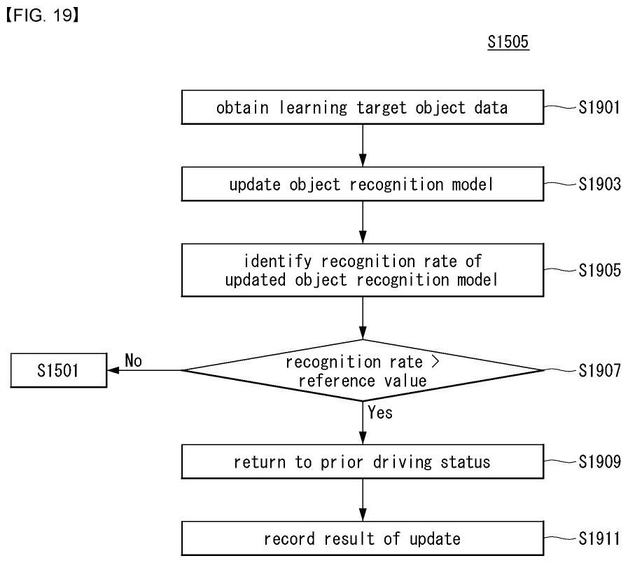

FIG. 19 is a flowchart illustrating a method of performing an update by a vehicle controller according to an embodiment of the present disclosure.

Referring to FIG. 19, the processor 170 of the vehicle controller 20 may obtain learning target object data from the server 30 (S1901).

Then, the processor 170 may update the object recognition model 171 based on the learning target object data (S1903).

Next, the processor 170 may identify (or verify) the recognition rate of the updated object recognition model 171 (S1905).

When the recognition rate, for a corresponding object, of the updated object recognition model 171 is larger than a reference value, the processor 170 may turn the driving status of the autonomous vehicle 10 back to the prior driving status before step S1501 (S1909).

When the recognition rate, for a corresponding object, of the updated object recognition model 171 is smaller than the reference value, the processor 170 may repeat step S1501 and its subsequent steps.

After returning to the prior driving status, the processor 170 may record the results of update in the memory 140 (S1911).

N. Summary of Embodiments of the Disclosure

### Embodiment 1

A method for controlling a vehicle in an autonomous driving system may comprise identifying an object recognition status of the vehicle, setting a driving route of the vehicle based on the object recognition status, and updating the object recognition status of the vehicle based on the driving route.

### Embodiment 2

In embodiment 1, the method may further comprise receiving verification data related to a particular object in a section where the vehicle drives from a server of the autonomous driving system, wherein identifying the object recognition status may include determining a recognition status for the particular object based on the verification data.

### Embodiment 3

In embodiment 2, determining the recognition status for the particular object may include determining whether a recognition rate, for the particular object, of an object recognition model included in the vehicle is a reference value or more.

### Embodiment 4

In embodiment 2, setting the driving route of the vehicle may include transmitting a result of the determination of the recognition status for the particular object to the server, obtaining a driving route set based on the result of the determination of the recognition status from the server, and changing the driving route of the vehicle to the driving route obtained from the server.

### Embodiment 5

In embodiment 4, changing the driving route of the vehicle may include changing a driving area of the vehicle to a driving area meeting a condition determined by the server based on the result of the determination of the recognition status.

### Embodiment 6

In embodiment 5, the driving area meeting the condition determined by the server may include an area in which a probability of presence of the particular object is a preset value or less.

### Embodiment 7

In embodiment 6, the driving area meeting the condition determined by the server may include an area with a section, in which the probability of presence of the particular object is the preset value or less, has a particular length or longer.

### Embodiment 8

In embodiment 7, the method may further comprise receiving, from a network, downlink control information (DCI) used for scheduling transmission of the object recognition status and transmitting the object recognition status to the network based on the DCI.

### Embodiment 9

In embodiment 5, the driving area meeting the condition determined by the server may include an area behind another vehicle, which is set based on the result of the determination of the recognition status from the server.

### Embodiment 10

In embodiment 9, updating the object recognition status of the vehicle may include receiving an allocation of a physical sidelink shared channel (PSSCH) for receiving information related to updating the object recognition status from the other vehicle via a preset physical sidelink control channel (PSCCH) and receiving the update-related information from the other vehicle via the PSSCH.

### Embodiment 11

An apparatus for controlling a vehicle in an autonomous driving system comprises a processor controlling a function of the vehicle, a camera coupled with the processor and capturing an ambient image of the vehicle, a memory coupled with the processor and storing data for controlling the vehicle, and a communication unit coupled with the processor and transmitting or receiving the data for controlling the vehicle, wherein the processor identifies an object recognition status of the vehicle based on the ambient image captured by the camera, sets a driving route of the vehicle based on the object recognition status, and updates the object recognition status of the vehicle based on the driving route.

### Embodiment 12

In embodiment 11, the processor may control the communication unit to receive verification data related to a particular object in a section where the vehicle drives from a server of the autonomous driving system and determines a recognition status for the particular object based on the verification data.

### Embodiment 13

In embodiment 12, the processor may determine whether a recognition rate, for the particular object, of an object recognition model included in the vehicle is a reference value or more.

### Embodiment 14

In embodiment 12, the processor may control the communication unit to transmit a result of the determination of the recognition status for the particular object to the server, control the communication unit to obtain a driving route set based on the result of the determination of the recognition status from the server, and change the driving route of the vehicle to the driving route obtained from the server.

### Embodiment 15

In embodiment 14, the processor may control the communication unit to change a driving area of the vehicle to a driving area meeting a condition determined by the server based on the result of the determination of the recognition status.

### Embodiment 16

In embodiment 15, the driving area meeting the condition determined by the server may include an area in which a probability of presence of the particular object is a preset value or less.

### Embodiment 17

In embodiment 16, the driving area meeting the condition determined by the server may include an area with a section, in which the probability of presence of the particular object is the preset value or less, has a particular length or longer.

### Embodiment 18

In embodiment 17, the processor may control the communication unit to receive, from a network, downlink control information (DCI) used for scheduling transmission of the object recognition status and transmit the object recognition status to the network based on the DCI.

### Embodiment 19

In embodiment 15, the driving area meeting the condition determined by the server may include an area behind another vehicle, which is set based on the result of the determination of the recognition status from the server.

### Embodiment 20

In embodiment 19, the processor may control the communication unit to receive an allocation of a physical sidelink shared channel (PSSCH) for receiving information related to updating the object recognition status from the other vehicle via a preset physical sidelink control channel (PSCCH) and receive the update-related information from the other vehicle via the PSSCH.

The vehicle may interact with at least one robot. The robot may be an autonomous mobile robot (AMR). The mobile robot is self-driving, thus free to travel, and includes multiple sensors to allow it to drive while avoiding, e.g., obstacles. The mobile robot may be a flight device-equipped flying robot (e.g., a drone). The mobile robot may be a wheeled robot with at least one wheel, which travels as the wheels roll. The mobile robot may be a legged robot with at least one leg, which provides locomotion.

The robot may function to aid in the vehicle user's convenience. For example, the robot may convey a load on the vehicle to the user's final destination. For example, the robot may direct the user who got out of the vehicle to the final destination. For example, the robot may transport the user who got out of the vehicle to the final destination.

At least one electronic device included in the vehicle may communicate with the robot via the communication device.

The at least one electronic device included in the vehicle may provide the robot with data processed by the electronic device. For example, the at least one electronic device included in the vehicle may provide the robot with at least any one of object data, high definition (HD) map data, vehicle status data, vehicle location data, and driving plan data.

The at least one electronic device included in the vehicle may receive data processed by the robot from the robot. The at least one electronic device included in the vehicle may receive at least any one of sensing data, object data, robot status data, robot location data, and robot moving plan data generated by the robot.

The at least one electronic device included in the vehicle may generate control signals further based on the data received from the robot. For example, the at least one electronic device included in the vehicle may compare object information generated by the object detecting device with object information generated by the robot and generate control signals based on the results of comparison. The at least one electronic device included in the vehicle may generate control signals without interference between the driving route of the vehicle and the driving route of the robot.

The at least one electronic device included in the vehicle may include a software module or hardware module (hereinafter, an artificial intelligence (AI) module) to implement AI. The at least one electronic device included in the vehicle may input obtained data to the AI module and use data output from the AI module.

The AI module may perform machine learning on the input data based on at least one artificial neural network (ANN). The AI module may output driving plan data by machine learning on the input data.

The at least one electronic device included in the vehicle may generate control signals based on the data output from the AI module.

According to an embodiment, the at least one electronic device included in the vehicle may receive data processed by AI from an external device through the communication device. The at least one electronic device included in the vehicle may generate control signals based on the data processed by AI.

The above-described disclosure may be implemented in computer-readable code in program-recorded media. The computer-readable media include all types of recording devices storing data readable by a computer system. Example computer-readable media may include hard disk drives (HDDs), solid state disks (SSDs), silicon disk drives (SDDs), ROMs, RAMs, CD-ROMs, magnetic tapes, floppy disks, and/or optical data storage, and may be implemented in carrier waveforms (e.g., transmissions over the Internet). The foregoing detailed description should not be interpreted not as limiting but as exemplary in all aspects. The scope of the present disclosure should be defined by reasonable interpretation of the appended claims and all equivalents and changes thereto should fall within the scope of the disclosure.

What is claimed is:

1. A method for controlling a vehicle in an autonomous driving system, the method comprising:
identifying an object recognition status of the vehicle;
setting a driving route of the vehicle based on the object recognition status; and
updating the object recognition status of the vehicle based on the driving route.

2. The method of claim 1, further comprising receiving verification data related to a particular object in a section where the vehicle drives from a server of the autonomous driving system, wherein identifying the object recognition status includes determining a recognition status for the particular object based on the verification data.

3. The method of claim 2, wherein identifying the recognition status for the particular object includes determining whether a recognition rate, for the particular object, of an object recognition model included in the vehicle is a reference value or more.

4. The method of claim 2, wherein setting the driving route of the vehicle includes:
transmitting a result of the determination of the recognition status for the particular object to the server;
obtaining a driving route set based on the result of the determination of the recognition status from the server; and
changing the driving route of the vehicle to the driving route obtained from the server.

5. The method of claim 4, wherein changing the driving route of the vehicle includes changing a driving area of the vehicle to a driving area meeting a condition determined by the server based on the result of the determination of the recognition status.

6. The method of claim 5, wherein the driving area meeting the condition determined by the server includes an area in which a probability of presence of the particular object is a preset value or less.

7. The method of claim 6, wherein the driving area meeting the condition determined by the server includes an area with a section, in which the probability of presence of the particular object is the preset value or less, has a particular length or longer.

8. The method of claim 7, further comprising:
receiving, from a network, downlink control information (DCI) used for scheduling transmission of the object recognition status; and
transmitting the object recognition status to the network based on the DCI.

9. The method of claim 5, wherein the driving area meeting the condition determined by the server includes an area behind another vehicle, which is set based on the result of the determination of the recognition status from the server.

10. The method of claim 9, wherein updating the object recognition status of the vehicle includes:
receiving an allocation of a physical sidelink shared channel (PSSCH) for receiving information related to updating the object recognition status from the other vehicle via a preset physical sidelink control channel (PSCCH); and
receiving the update-related information from the other vehicle via the PSSCH.

11. An apparatus for controlling a vehicle in an autonomous driving system, the apparatus comprising:
a processor controlling a function of the vehicle;
a camera coupled with the processor and capturing an ambient image of the vehicle;
a memory coupled with the processor and storing data for controlling the vehicle; and
a transceiver coupled with the processor and transmitting or receiving the data for controlling the vehicle, wherein the processor identifies an object recognition status of the vehicle based on the ambient image captured by the camera, sets a driving route of the vehicle based on the object recognition status, and updates the object recognition status of the vehicle based on the driving route.

12. The apparatus of claim 11, wherein the processor controls the transceiver to receive verification data related to a particular object in a section where the vehicle drives from a server of the autonomous driving system and determines a recognition status for the particular object based on the verification data.

13. The apparatus of claim 12, wherein the processor determines whether a recognition rate, for the particular object, of an object recognition model included in the vehicle is a reference value or more.

14. The apparatus of claim 12, wherein the processor controls the transceiver to transmit a result of the determination of the recognition status for the particular object to the server, controls the transceiver to obtain a driving route set based on the result of the determination of the recognition status from the server, and changes the driving route of the vehicle to the driving route obtained from the server.

15. The apparatus of claim 14, wherein the processor controls the transceiver to change a driving area of the vehicle to a driving area meeting a condition determined by the server based on the result of the determination of the recognition status.

16. The apparatus of claim 15, wherein the driving area meeting the condition determined by the server includes an area in which a probability of presence of the particular object is a preset value or less.

17. The apparatus of claim 16, wherein the driving area meeting the condition determined by the server includes an area with a section, in which the probability of presence of the particular object is the preset value or less, has a particular length or longer.

18. The apparatus of claim 17, wherein the processor controls the transceiver to receive, from a network, downlink control information (DCI) used for scheduling transmission of the object recognition status and transmit the object recognition status to the network based on the DCI.

19. The apparatus of claim 15, wherein the driving area meeting the condition determined by the server includes an area behind another vehicle, which is set based on the result of the determination of the recognition status from the server.

20. The apparatus of claim 19, wherein the processor controls the transceiver to receive an allocation of a physical sidelink shared channel (PSSCH) for receiving information related to updating the object recognition status from the other vehicle via a preset physical sidelink control channel (PSCCH) and receive the update-related information from the other vehicle via the PSSCH.
